(19) United States
(12) Patent Application Publication
(10) Pub. No.: US 2010/0045870 A1
(43) Pub. Date: Feb. 25, 2010

(54) ADAPTIVE NOISE REDUCTION SYSTEM

(75) Inventor: Po-Wei CHAO, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/197,469

(22) Filed: Aug. 25, 2008

(51) Int. Cl. H04N 5/00

(52) U.S. Cl. 348/607; 348/E05.001

(57) ABSTRACT

A noise reduction system is provided. In a temporal module, a temporal characteristic detector detects a temporal characteristic of the input image based on the input image and a reference image. A temporal filter performs temporal noise reduction on the input image based on the reference image and the temporal characteristic to generate a temporal filtered image. A temporal selector selects the temporal filtered image or the input image as a preliminary output accordingly. In a spatial module, a spatial characteristic of the input image is detected. A spatial filter performs spatial noise reduction on the input image based on the preliminary output and the spatial characteristic to generate a spatial filtered image. A spatial selector selects the spatial filtered image or the preliminary output as the output image based on the temporal or spatial characteristics.

### BACKGROUND OF THE INVENTION

1. Field of the Invention

The invention relates to noise reduction, and in particular, to integrated circuit architectures in which temporal and spatial noise reductions are performed cooperatively.

2. Description of the Related Art

Noise reduction is an essential stage in a digital image processor. Generally, an image displayed on a digital display can be a still image or a motion picture. Noise may be induced when rendering the image or when transmitting the image from a source device to a destination device, and can be categorized into two types, temporal noise and spatial noise. Temporal noise is assessed if a pixel in a still image varies with time. Spatial noise is usually defined as a certain high frequency pattern in one single image, such as white Gaussian noise. A typical motion picture is represented by a series of consecutive frames, and conventionally, temporal and spatial noise reductions are separately processed for each frame.

Regarding temporal noise reduction, when a current input image is processed to reduce temporal noise, each pixel therein is compared with a corresponding pixel in a previous frame. If the variation between a current pixel and a previous pixel exceeds a threshold, the pixel is assessed as being affected by the temporal noise and an algorithm may be used to average the pixel based on one or more corresponding pixels in one or more previous frames. In this way, the influence caused by the temporal noise can be reduced.

With regard to spatial noise reduction, spatial noise is generally assessed as a high frequency pattern. The frequency spectrum of an image is compared with a certain threshold to determine whether a spatial filtering process should be enabled. An edge features a high frequency spectrum, and may be falsely detected as a spatial noise. To avoid an edge being blurred by the spatial filtering process, edge detection is required. For example, if a pixel in the image is assessed to be an edge, the pixel is bypassed in the spatial filtering process.

A still image can be represented as a plurality of identical input images, and any variation therein can be assessed as temporal noises. However, if a temporal noise reduction is performed on a motion picture, the sharpness of each input image may be blurred, and the temporal filtered output may suffer from sticking effects that significantly reduce display quality. On the other hand, it is ineffective to perform temporal noise reduction on still images. Thus, it is desirable to propose an enhancement, wherein the temporal and spatial noise reductions are adaptively enabled.

### BRIEF SUMMARY OF THE INVENTION

An exemplary embodiment of a noise reduction system is disclosed, processing an input image to generate an output image. The noise reduction system comprises a temporal module and a spatial module. The temporal module comprises a temporal characteristic detector for detecting a temporal characteristic of the input image based on the input image and a reference image to generate a first selection signal, accordingly. A temporal filter performs temporal noise reduction on the input image based on the reference image and the temporal characteristic to generate a temporal filtered image. A temporal selector selects one of the temporal filtered image and the input image as a preliminary output based on the first selection signal. In the spatial module, a spatial characteristic detector detects a spatial characteristic of the input image based on the preliminary output to generate a second selection signal. A spatial filter performs spatial noise reduction on the input image based on the preliminary output and the temporal characteristic to generate a spatial filtered image. A spatial selector selects one of the spatial filtered image and the preliminary output as the output image based on at least one of the first selection signal and second selection signal.

Another embodiment of a noise reduction system comprises a spatial module followed by a temporal module. In the spatial module, a spatial characteristic detector detects a spatial characteristic of the input image to generate a first selection signal. A spatial filter performs spatial noise reduction on the input image based on the input image and the spatial characteristic to generate a spatial filtered image. A spatial selector selects one of the spatial filtered image and the input image as a preliminary output based on the first selection signal. In the temporal module, a temporal characteristic detector detects a temporal characteristic of the input image based on the preliminary output and a reference image to generate a second selection signal, accordingly. A temporal filter performs temporal noise reduction on the preliminary output based on the reference image and the temporal characteristic to generate a temporal filtered image. A temporal selector selects one of the temporal filtered image and the preliminary output as the output image based on the second selection signal.

In a further embodiment, a noise reduction system comprises a temporal module and a spatial module cascaded in parallel to operate concurrently. The temporal module comprises a temporal characteristic detector for detecting a temporal characteristic of the input image based on the input image and a reference image to generate a first selection signal, accordingly, and a first temporal filter for performing temporal noise reduction on the input image based on the reference image and the temporal characteristic to generate a first temporal filtered image. In the spatial module, a spatial characteristic detector detects a spatial characteristic of the input image based on the input image to generate a second selection signal. A first spatial filter performs spatial noise reduction on the input image based on the input image and the spatial characteristic to generate a first spatial filtered image. A decision unit performs an organization process to render the output image from pixels of the first temporal filtered image, first spatial filtered image and the input image based on the first selection signal and the second selection signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1a to 1f show embodiments of noise reduction processors according to the invention;

FIGS. 2a to 2d show alternate embodiments of noise reduction processors according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

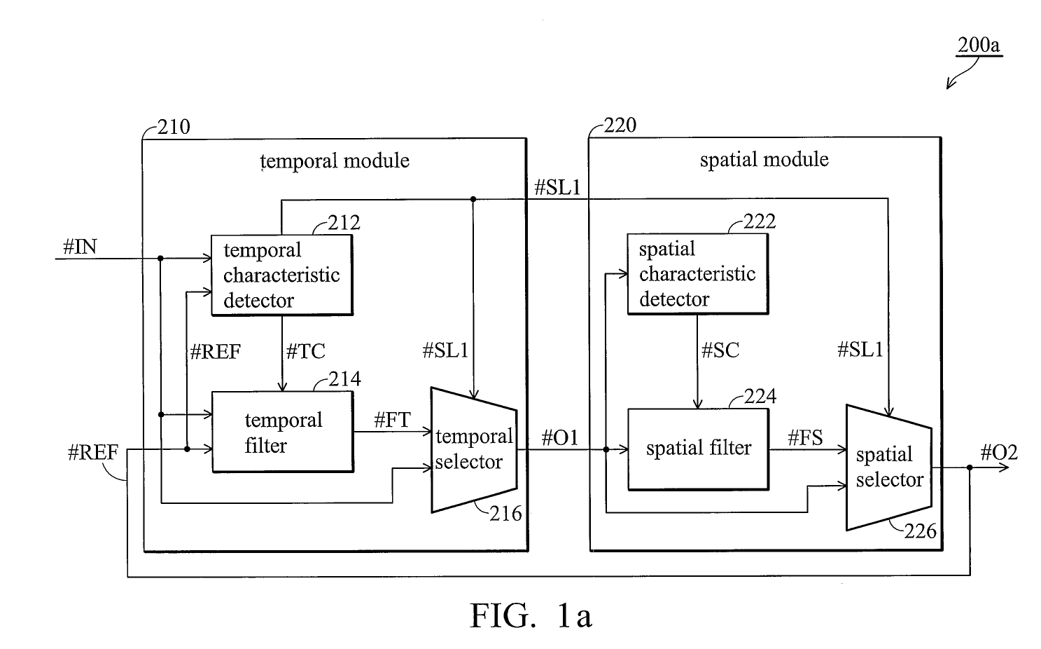

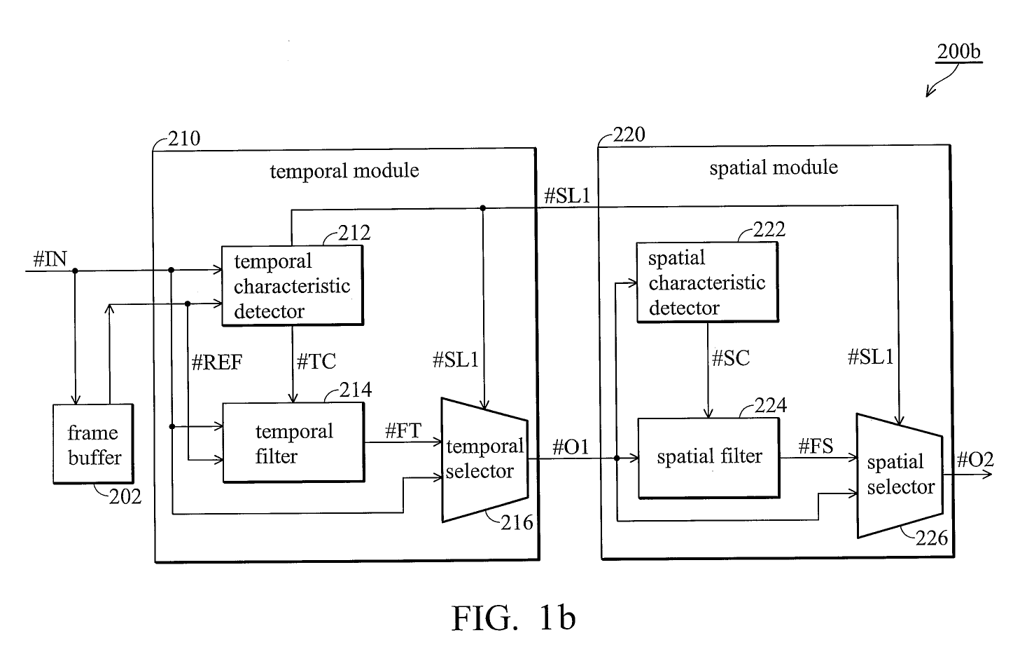

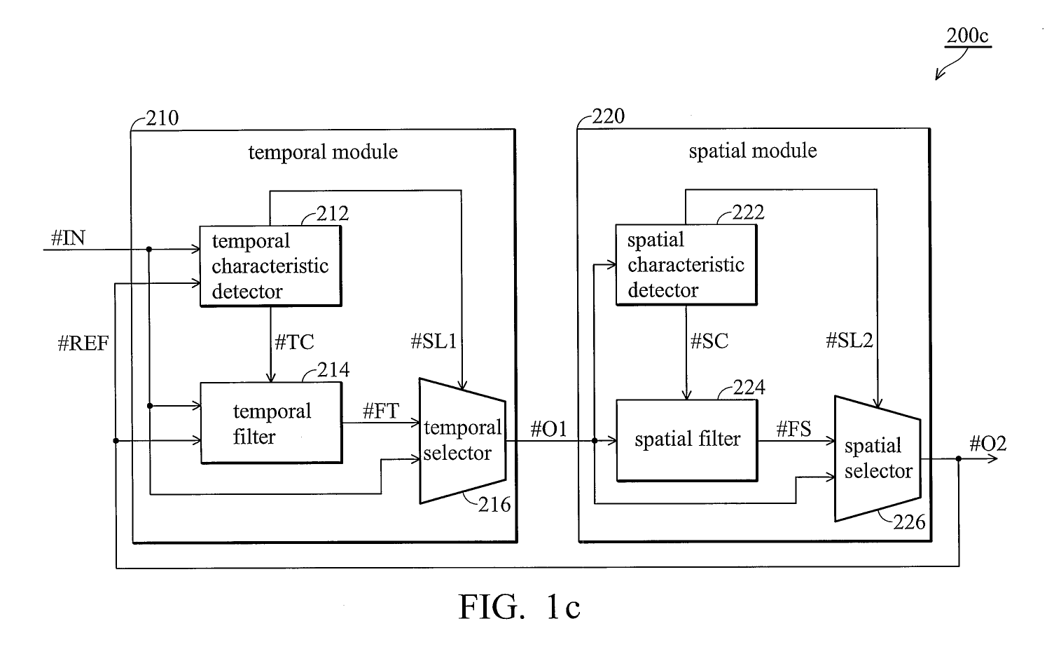

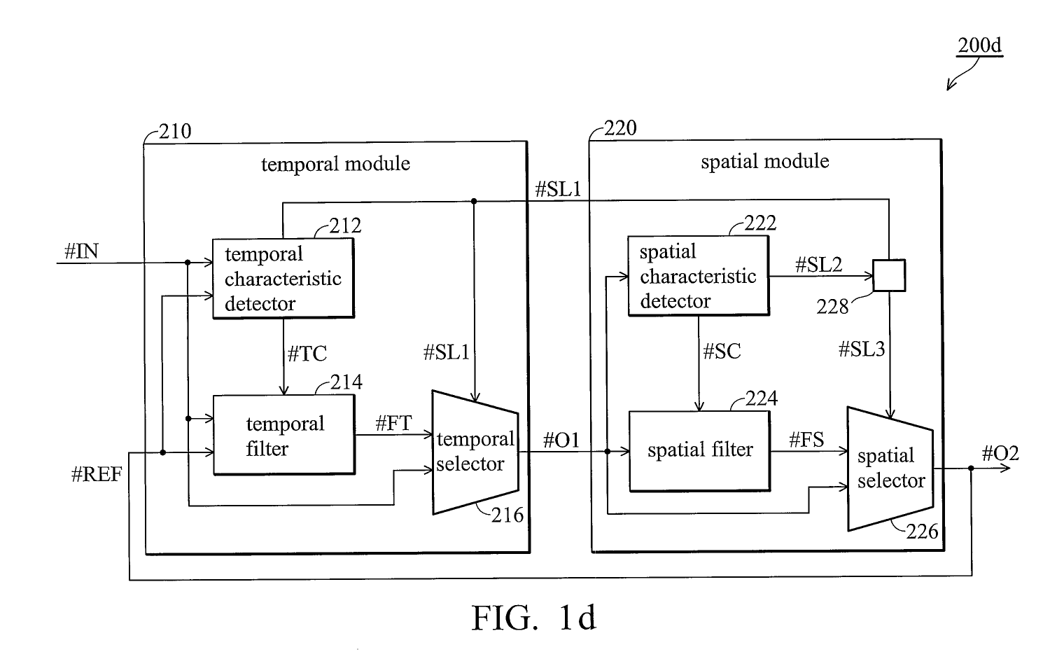

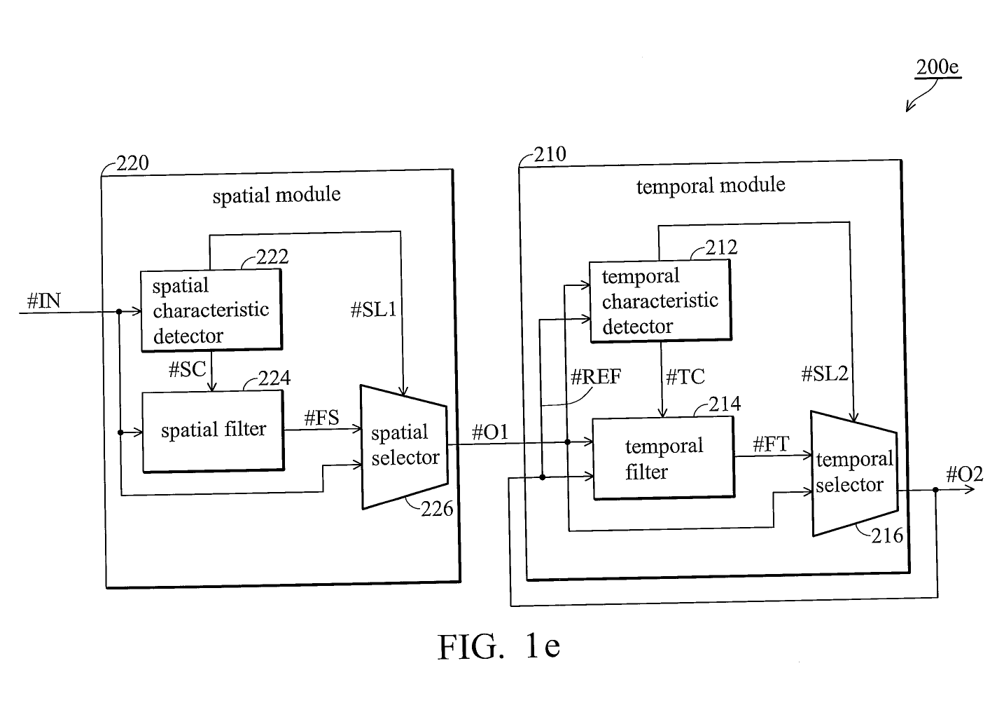

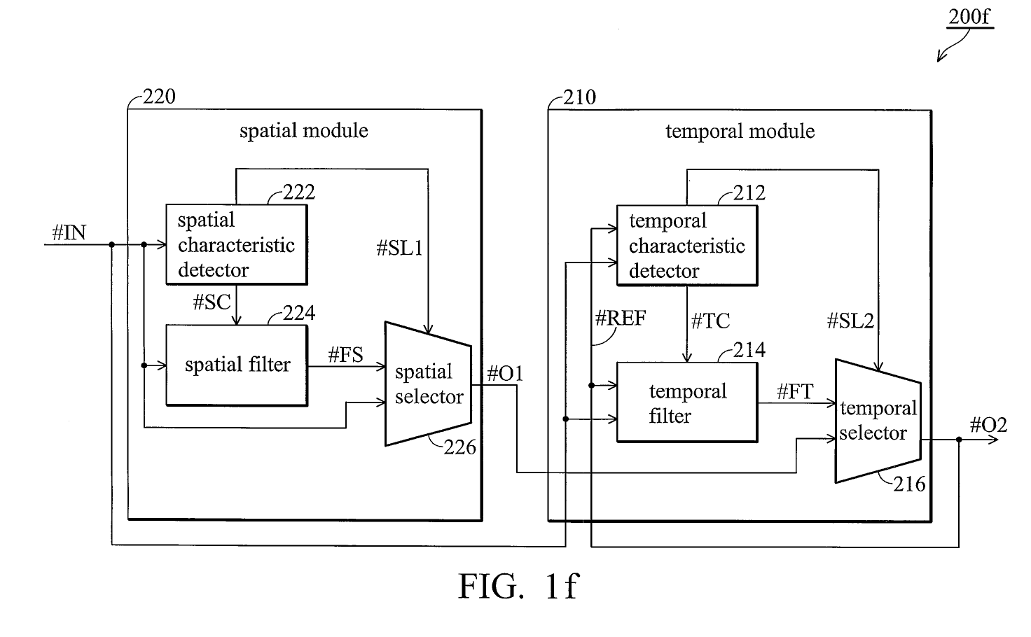

To improve the quality of image processing, the embodiments of noise reduction systems selectively determine whether temporal noise reduction or spatial noise reduction shall be enabled or disabled based on characteristics obtained from either a temporal characteristic detector 212 or a spatial characteristic detector 222, and detailed examples are introduced in FIGS. 1a to 1f.

FIG. 1a shows an embodiment of a noise reduction processor 200a according to the invention, comprising a temporal module 210 and a spatial module 220. The temporal module 210 generates a preliminary output #O1 from the input image #IN, and the spatial module 220 generates an output image #O2 from the preliminary output #O1. The temporal module 210 comprises a temporal characteristic detector 212, a temporal filter 214, and a temporal selector 216. The temporal characteristic detector 212 detects a temporal characteristic #TC of the input image #IN based on the input image #IN and a reference image #REF to generate the first selection signal #SL1. A temporal selector 216 is provided to operate based on the first selection signal #SL1 sent from the temporal characteristic detector 212. Specifically, the temporal selector 216 may be implemented by a switching mechanism that receives two inputs and selects one of them to be an output. The temporal characteristic #TC may be representative of various features of the input image #IN, such as motion characteristics indicating whether the input image #IN is moving. In the embodiment of FIG. 1a, the reference image #REF is the output image #O2 fed back from the spatial module 220. The temporal characteristic #TC is sent to the temporal filter 214, and the temporal filter 214 performs temporal noise reduction on the input image #IN based on the reference image #REF and the temporal characteristic #TC to generate a temporal filtered image #FT. The algorithm for temporal noise reduction is a well-known prior art, so detailed description is omitted herein. The temporal characteristic detector 212 compares the input image #IN and the reference image #REF to determine motion characteristics or edge characteristics, and the determination results are used to decide whether temporal noise reduction shall be performed. For example, if the input image #IN is motionless, the temporal characteristic detector 212 sends the first selection signal #SL1 to direct the temporal selector 216 to select the temporal filtered image #FT as the preliminary output #O1. Otherwise, if the input image #IN is moving, the temporal characteristic detector 212 sends the first selection signal #SL1 to direct the temporal selector 216 to select the input image #IN as the preliminary output #O1.

The temporal module 210 is followed by a spatial module 220 comprising a spatial characteristic detector 222 and a spatial filter 224, and a spatial selector 226. The spatial selector 226 is operated to select between the preliminary output #O1 and a spatial filtered image #FS as the output image #O2 based on the first selection signal #SL1 sent from the temporal characteristic detector 212. The preliminary output #O1 output from the temporal selector 216 is first detected by the spatial characteristic detector 222 to obtain a spatial characteristic #SC. The spatial characteristic #SC detected by the spatial characteristic detector 222 may be representative of various features such as edge characteristics of a pixel in the preliminary output #O1, luminance of the pixel, or chrominance of the pixel. The spatial filter 224 then performs spatial noise reduction on the preliminary output #O1 based on the spatial characteristic #SC to generate the spatial filtered image #FS. The algorithm for spatial noise reduction is a well-known prior art technique, whereby line buffers (not shown) may be used to compare adjacent pixels. Detailed description of the algorithm for spatial noise reduction is omitted herein.

If the temporal selector 216 selects the input image #IN as the preliminary output #O1, which means temporal noise reduction performed by the temporal module 210 is not required. Likewise, if the spatial selector 226 selects the preliminary output #O1 as the output image #O2, spatial noise reduction performed by the spatial module 220 is not required. Therefore, based on the architecture, it is possible to implement a noise reduction processor in which the temporal and spatial noise reductions are adaptively enabled or disabled. In the embodiment of FIG. 1a, both the temporal selector 216 and spatial selector 226 are controlled by the first selection signal #SL1 generated from the temporal characteristic detector 212, and the first selection signal #SL1 is dependent on the temporal characteristic #TC detected by the temporal characteristic detector 212. In other words, the enablement or disablement of temporal and spatial noise reductions are dependent on the temporal characteristic #TC which may comprise various features of the input image #IN such as motion and edge characteristics.

FIG. 1b shows another embodiment of a noise reduction processor 200b according to the invention. Like the embodiment in FIG. 1a, a temporal module 210 and a spatial module 220 are provided. A frame buffer 202 is further provided to buffer the input image #IN. The frame buffer 202 is essential to buffer input image #IN of a previous frame and output it as a current reference image #REF, such that the temporal characteristic detector 212 and temporal filter 214 can operate, accordingly. The temporal characteristic detector 212 then compares the input image #IN and the reference image #REF to determine the motion characteristic of the input image #IN.

Regarding the spatial module 220 in FIG. 1b, if the temporal filtered image #FT is selected as the preliminary output #O1 the spatial selector 226 selects the preliminary output #O1 to be the output image #O2. Conversely, if the temporal selector 216 selects the input image #IN as the preliminary output #O1, the spatial selector 226 selects the spatial filtered image #FS as the output image #O2. In this way, spatial noise reduction and temporal noise reduction are exclusively enabled based on the temporal characteristic #TC. Unlike the embodiment of FIG. 1a, the reference image #REF of FIG. 1b is obtained from the frame buffer 202.

FIG. 1c shows another embodiment of a noise reduction processor according to the invention. Like the embodiment in FIG. 1a, a temporal module 210 and a spatial module 220 are provided. Rather than the first selection signal #SL1, the operation of the spatial selector 226 is dependent on a second selection signal #SL2 generated by the spatial characteristic detector 222. The spatial characteristic #SC detected by the spatial characteristic detector 222 may comprise an edge characteristic of the preliminary output #O1. If a pixel in the preliminary output #O1 is identified as an edge, the pixel is inadequate for spatial noise reduction, so the spatial characteristic detector 222 sends the second selection signal #SL2 to direct the spatial selector 226 to select the pixel from a preliminary output #O1 to organize the output image #O2. Conversely, if the pixel in the preliminary output #O1 is not an edge, spatial noise reduction is allowable, and hence the spatial characteristic detector 222 sends the second selection signal #SL2 to direct the spatial selector 226 to select a corresponding pixel from the spatial filtered image #FS to organize the output image #O2.

Further, the spatial characteristic #SC may represent luminance and/or chrominance of each pixel, and the second selection signal #SL2 is determined based thereon. For example, luminance of a pixel is compared with a luminance threshold to determine the second selection signal #SL2. If luminance of a pixel in the preliminary output #O1 exceeds a luminance threshold, the spatial characteristic detector 222 sends the second selection signal #SL2 to direct the spatial selector 226 to select the pixel to organize the output image #O2. Conversely, if the luminance of the pixel does not exceed the luminance threshold, the spatial characteristic detector 222 sends the second selection signal #SL2 to direct the spatial selector 226 to select a corresponding pixel from the spatial filtered image #FS to organize the output image #O2.

Likewise, chrominance of a pixel may also be compared with a chrominance threshold to determine the second selection signal #SL2. More flexibly, various characteristics may be jointly considered when determining the second selection signal #SL2. For example, the edge characteristics, the luminance characteristics and the chrominance characteristics may be submitted into a predetermined formula to decide whether the spatial filtered image #FS or the preliminary output #O1 is used to contribute to the output image #O2, and the formula may be flexibly programmed in firmware or an operating system.

FIG. 1d shows another embodiment of a noise reduction processor 200d according to the invention. Like the embodiment in FIG. 1c, the temporal characteristic detector 212 generates a first selection signal #SL1 based on the temporal characteristic #TC, and the spatial characteristic detector 222 generates a second selection signal #SL2 based on the spatial characteristic #SC. A decision unit 228 is further provided, coupled to the temporal characteristic detector 212 and the spatial characteristic detector 222, performing a logic decision based on the first selection signal #SL1 and second selection signal #SL2 to generate a third selection signal #SL3. For example, when the first and second selection signals, #SL1 and #SL2, respectively represents the likelihood of motion and edge characteristics, the logic decision based on the first selection signal #SL1 and second selection signal #SL2 can be performed by comparing the first selection signal #SL1 and second selection signal #SL2 to obtain the third selection signal #SL3. Therefore, when the first selection signal #SL1 indicating the likelihood of the input image #IN being motionless is smaller than the second selection signal #SL2 indicating the likelihood of a pixel in the preliminary output #O1 not being a pixel, the third selection signal #SL3 may be generated by the decision unit 228 to direct the spatial selector 226 to select a corresponding pixel from the spatial filtered image #FS to organize the output image #O2. In this way, various characteristics such as edge characteristics, motion characteristics, luminance characteristics and chrominance characteristics may be jointly considered when determining the third selection signal #SL3. The third selection signal #SL3 is then sent to the spatial selector 226 as a basis to organize the output image #O2. Since both temporal characteristic #TC and spatial characteristic #SC are taken into account, a predetermined formula may be employed by the decision unit 228 to determine the third selection signal #SL3. For example, the edge characteristics, motion characteristics and the luminance characteristics may be submitted into a predetermined formula to decide whether the spatial filtered image #FS or the preliminary output #O1 is used to contribute to the output image #O2, and the formula may be flexibly programmed in firmware or an operating system.

FIG. 1e an alternative embodiment of a noise reduction processor 200e according to the invention. In the embodiment, the spatial module 220 is followed by the temporal module 210. The spatial module 220 receives input image #IN to generate a preliminary output #O1, and the temporal module 210 receives the preliminary output #O1 to generate an output image #O2. The spatial module 220 comprises similar architecture as described in FIGS. 1a to 1d. A spatial characteristic detector 222 detects a spatial characteristic #SC of the input image #IN based on the input image #IN to generate a first selection signal #SL1. A spatial filter 224 performs spatial noise reduction on the input image #IN based on the input image #IN and the spatial characteristic #SC to generate a spatial filtered image #FS. A spatial selector 226 selects the spatial filtered image #FS or the input image #IN as the preliminary output #O1 based on the first selection signal #SL1. According to the arrangement, it is possible to enable or disable spatial noise reduction based on the spatial characteristic #SC.

The temporal module 210 is coupled to the spatial selector 226, comprising a temporal characteristic detector 212, a temporal filter 214 and a temporal selector 216. The temporal characteristic detector 212 detects a temporal characteristic #TC of the input image #O1 based on the preliminary output #O1 and a reference image #REF to generate a second selection signal #SL2, accordingly. Like the embodiment of FIG. 1a, the reference image #REF may be acquired by directly feeding back the output image #O2. A frame buffer (not shown) as the frame buffer 202 of FIG. 1b may also be implemented instead. The temporal filter 214 then performs temporal noise reduction on the preliminary output #O1 based on the reference image #REF and the temporal characteristic #TC to generate a temporal filtered image #FT. A temporal selector 216 selects the temporal filtered image #FT or the preliminary output #O1 as the output image #O2 based on the second selection signal #SL2.

In the spatial module 220, the input image #IN is processed pixel by pixel, and the preliminary output #O1 is a mixture of pixels from either the spatial filtered image #FS or the input image #IN. The spatial characteristic #SC detected by the spatial characteristic detector 222 may comprise edge characteristics, luminance characteristics, or chrominance characteristics of each pixel in the input image #IN. For example, if a pixel in the input image #IN is identified as an edge, the spatial characteristic detector 222 sends the first selection signal #SL1 to direct the spatial selector 226 to select the pixel from the input image #IN to organize the preliminary output #O1. Conversely, if the pixel in the input image #IN is not an edge, the spatial characteristic detector 222 sends the first selection signal #SL1 to direct the spatial selector 226 to select a corresponding pixel from the spatial filtered image #FS as the preliminary output #O1.

Similarly, luminance and chrominance of each pixel may also be considered when organizing the preliminary output #O1. For example, if luminance of a pixel in the input image #IN exceeds a luminance threshold, the spatial characteristic detector 222 sends the first selection signal #SL1 to direct the spatial selector 226 to select the pixel to organize the preliminary output #O1. Conversely, if the luminance does not exceed the luminance threshold, the spatial characteristic detector 222 sends the first selection signal #SL1 to direct the spatial selector 226 to select a corresponding pixel from the spatial filtered image #FS to organize the preliminary output #O1. Chrominance of each pixel may be considered in a similar way, which is omitted herein for brevity.

Various further characteristics may be jointly considered when determining the first selection signal #SL1, and the invention is not limited. For example, the edge characteristics, luminance characteristics, and chrominance characteristics may be submitted into a predetermined formula to decide whether a pixel in the spatial filtered image #FS or the input image #IN should be output to contribute the output image #O1 and the formula may be flexibly programmed in firmware or an operating system.

In the temporal module 210, the preliminary output #O1 is processed frame by frame. The temporal characteristic detector 212 compares a current frame with a previous frame to detect motions of the current frame. For example, the preliminary output #O1 is the current frame, and the reference image #REF is the previous frame. If the preliminary output #O1 is motionless, the temporal characteristic detector 212 sends the second selection signal #SL2 to direct the temporal selector 216 to select the temporal filtered image #FT as the output image #O2. Conversely, if the preliminary output #O1 is moving, the temporal characteristic detector 212 sends the second selection signal #SL2 to direct the temporal selector 216 to select the preliminary output #O1 as the output image #O2.

FIG. 1f shows an alternative embodiment of a noise reduction processor 200f according to the invention. The embodiment is similar to the structure of FIG. 1e except that the input image #IN is sent to the temporal characteristic detector 212 and temporal filter 214 for processing. The temporal characteristic detector 212 compares a current frame with a previous frame to detect motions of the current frame, where the current frame is the input image #IN, and the previous frame is the reference image #REF. If the input image #IN is detected as being motionless, the temporal characteristic detector 212 sends the second selection signal #SL2 to direct the temporal selector 216 to select the temporal filtered image #FT as the output image #O2. Conversely, if the input image #IN is moving, the temporal characteristic detector 212 sends the second selection signal #SL2 to direct the temporal selector 216 to select the preliminary output #O1 as the output image #O2. The reference image #REF in the embodiment is acquired by feeding back the output image #O2, however, a frame buffer (not shown) may also be implemented to provide the reference image #REF.

FIGS. 1a to 1f show cascaded structures in which the temporal module 210 and spatial module 220 are sequentially processed, and the following embodiments introduce parallel structures in which temporal and spatial noise reductions are concurrently processed.

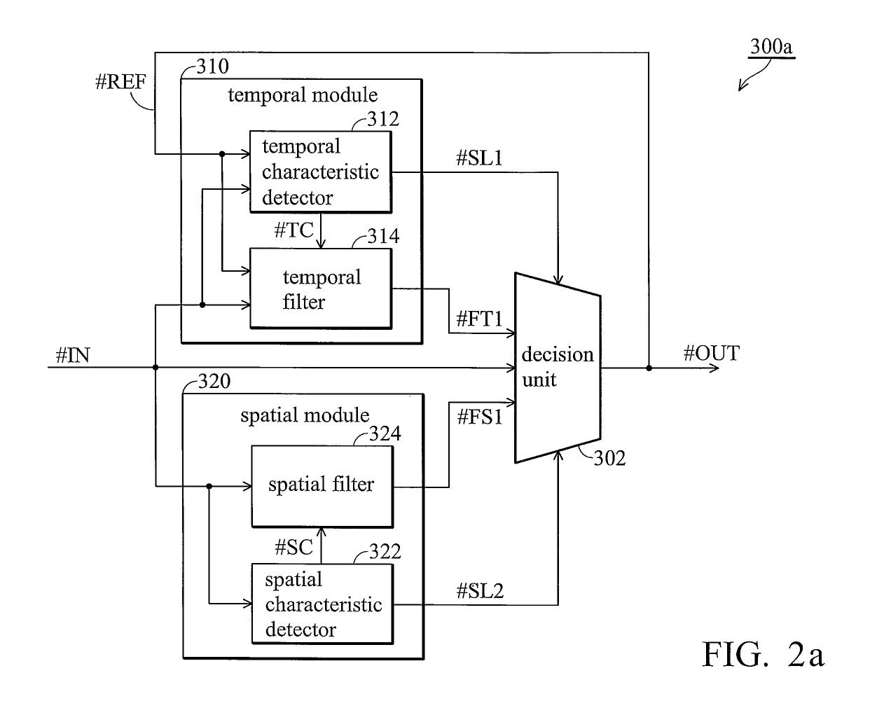

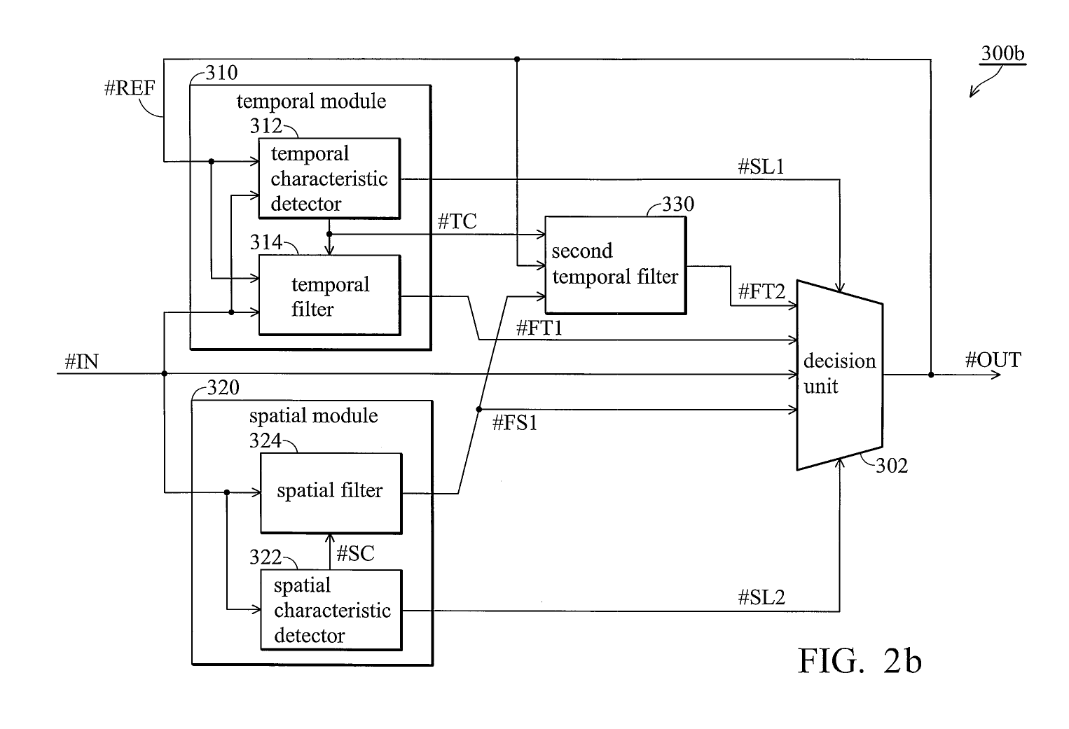

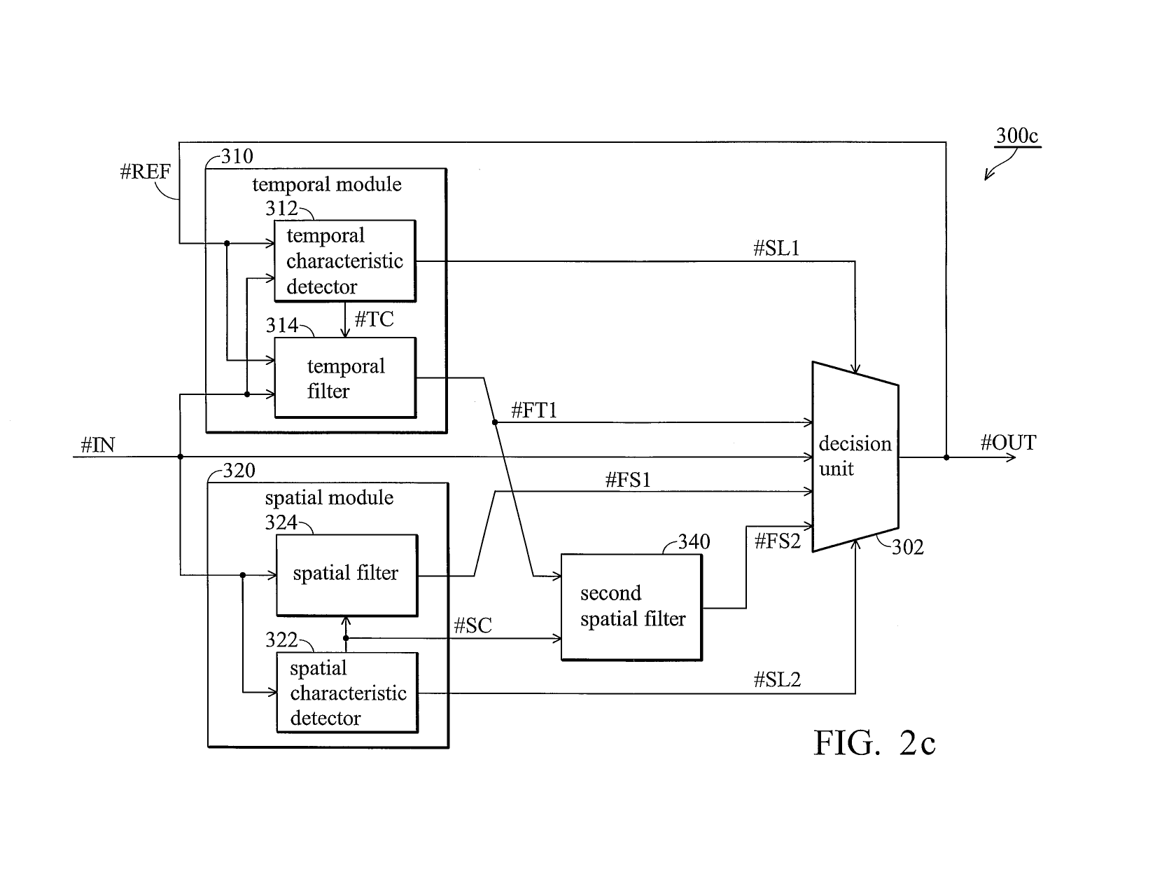

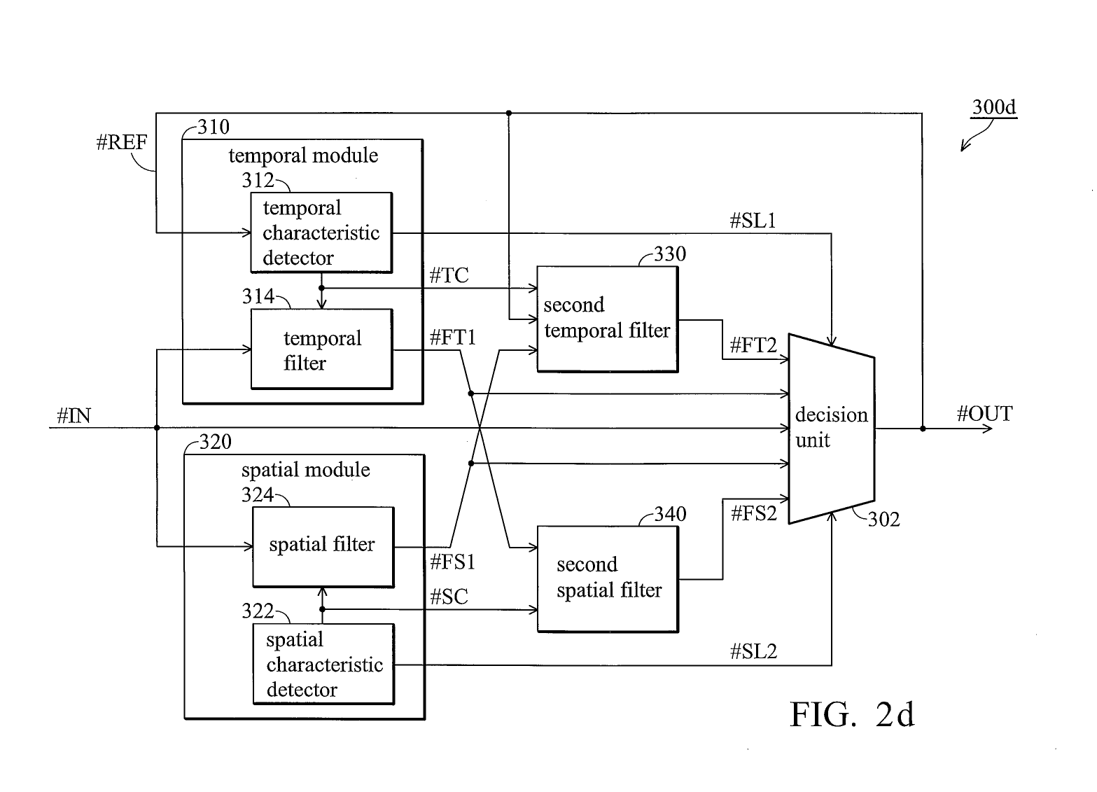

FIG. 2a shows an embodiment of a noise reduction system 300a. The noise reduction system 300a comprises a temporal module 310 and a spatial module 320 arranged in parallel, through which an input image #IN is converted into an output image #OUT. Generally, the input image #IN is a pixel stream in which noise reduction is processed pixel by pixel, and respectively, the output image #OUT is organized by processed pixel streams output from the temporal module 310 and the spatial module 320. The temporal module 310 comprises a temporal characteristic detector 312 and a first temporal filter 314. The temporal characteristic detector 312 detects a temporal characteristic #TC of the input image #IN based on the input image #IN and the output image #OUT to generate a first selection signal #SL1, accordingly, and the first temporal filter 314 performs temporal noise reduction on the input image #IN based on the reference image #REF and the temporal characteristic #TC to generate a first temporal filtered image #FT1. The spatial module 320 comprises a spatial characteristic detector 322 for detecting a spatial characteristic #SC of the input image #IN based on the input image #IN to generate a second selection signal #SL2, and a first spatial filter 324 for performing spatial noise reduction on the input image #IN based on the input image #IN and the spatial characteristic #SC to generate a first spatial filtered image #FS1. In the embodiment, a decision unit 302 is further provided, coupled to the temporal module 310 and spatial module 320, performing an organization process based on the first selection signal #SL1 and the second selection signal #SL2 to render the output image #OUT from the first temporal filtered image #FT1, the first spatial filtered image #FS1 and the input image #IN.

As described, the temporal characteristic #TC may comprise various features such as a motion characteristic of the input image #IN. The spatial characteristic #SC may represent an edge characteristic, a luminance characteristic and/or chrominance characteristic of each pixel in the input image #IN. In the temporal module 310, the temporal characteristic detector 312 compares the input image #IN and the output image #OUT to determine the motion characteristic. If the input image #IN is motionless, the temporal characteristic detector 312 sends the first selection signal #SL1 to direct the decision unit 302 to select the first temporal filtered image #FT1 as the output image #OUT. Conversely, if the input image #IN is moving, the temporal characteristic detector 312 sends the first selection signal #SL1 to direct the decision unit 302 to select the input image #IN as the output image #OUT.

Concurrently, the spatial characteristic detector 322 operates to analyze the input image #IN. If a pixel in the input image #IN is identified as an edge, the spatial characteristic detector 322 sends the second selection signal #SL2 to direct the decision unit 302 to select the pixel from the input image #IN to organize the output image #OUT, and if the pixel is not an edge, the temporal characteristic detector 322 sends the second selection signal #SL2 to direct the decision unit 302 to select a corresponding pixel from the first spatial filtered image #FS1 to organize the output image #OUT.

Luminance of each pixel is also considered when performing spatial noise reduction. For example, if a luminance of a pixel in the input image #IN exceeds a luminance threshold, the spatial characteristic detector 322 sends the second selection signal #SL2 to direct the decision unit 302 to select the pixel from the input image #IN to organize the output image #OUT. Conversely, if the luminance does not exceed the luminance threshold, the spatial characteristic detector 322 sends the second selection signal #SL2 to direct the decision unit 302 to select a corresponding pixel from the first spatial filtered image #FS1 to organize the output image #OUT. As described previously, chrominance of each pixel may be considered in a similar way, which is omitted herein for brevity.

The temporal noise reduction requires a previous frame as the reference image #REF for comparison. In the embodiment, the output image #OUT is fed back to the temporal module 310 to be the previous frame. It is known that a frame buffer (not shown) may also be implemented in the temporal module 310 to buffer a current frame and to provide a previous frame. When multiple characteristics are jointly considered to make a selection among the three inputs such as the first temporal filtered image #FT1, the input image #IN and the first spatial filtered image #FS1, a logic decision similar to that performed by the decision unit 228 of FIG. 1d may be made according to the first selection signal #SL1 and the second selection signal #SL2. The logic decision can be a software program implemented in the decision unit 302. Consequently, the output image #OUT rendered from the decision unit 302 may comprise pixels conditionally selected from the first temporal filtered image #FT1, the input image #IN and the first spatial filtered image #FS1.

FIG. 2b shows an alternative embodiment of a noise reduction system 300b. The noise reduction system 300b is modified according to the noise reduction system 300a in FIG. 2a, with a second temporal filter 330 further added. The second temporal filter 330 is coupled to the first spatial filter 324 and the temporal characteristic detector 312, performing a further temporal noise reduction on the first spatial filtered image #FS1 based on the temporal characteristic #TC and the output image #OUT to generate a second temporal filtered image #FT2. Consequently, the second temporal filtered image #FT2 is a result in which spatial noise and temporal noise are both processed. In the embodiment, pixels of the first temporal filtered image #FT1, the second temporal filtered image #FT2, the first spatial filtered image #FS1 and the input image #IN are selectively reorganized by the decision unit 302 based on the first selection signal #SL1 and the second selection signal #SL2 to render the output image #OUT.

FIG. 2c shows an alternative embodiment of a noise reduction system 300c. The noise reduction system 300c is modified according to the noise reduction system 300a in FIG. 2a, with a second spatial filter 340 further added. The second spatial filter 340 is coupled to the first temporal filter 314 and the spatial characteristic detector 322, performing a further spatial noise reduction on the first temporal filtered image #FT1 based on the spatial characteristic #SC to generate a second spatial filtered image #FS2. Consequently, the second spatial filtered image #FS2 is a result, in which spatial noise and temporal noise are both processed. In the embodiment, pixels of the first temporal filtered image #FT1, the first spatial filtered image #FS1, the second spatial filtered image #FS2 and the input image #IN are selectively reorganized by the decision unit 302 based on the first selection signal #SL1 and the second selection signal #SL2 to render the output image #OUT.

FIG. 2d shows a further embodiment of a noise reduction system 300d, including both the second temporal filter 330 and the second spatial filter 340 as described respectively in the embodiments of FIGS. 2b and 2c. Consequently, pixels of the first temporal filtered image #FT1, the second temporal filtered image #FT2, the first spatial filtered image #FS1, the second spatial filtered image #FS2 and the input image #IN are selectively reorganized by the decision unit 302 based on the first selection signal #SL1 and the second selection signal #SL2 to render the output image #OUT. The five inputs sent to the decision unit 302 respectively represent noise reduction results in different methods. For example, the input image #IN may be the original data source without any process, the first temporal filtered image #FT1 and first spatial filtered image #FS1 may be single stage processed results, and the second temporal filtered image #FT2 and second spatial filtered image #FS2 may be two-staged processed results. The decision unit 302 may execute a predetermined selection algorithm to pick pixels from the five inputs to organize the output image #OUT according to the first selection signal #SL1 and the second selection signal #SL2. Some pixels of the input image #IN may require both temporal and spatial noise reductions, thus the second temporal filtered image #FT2 or the second spatial filtered image #FS2 would be selected. Other pixels may be inadequate for any noise reduction, so the input image #IN would be selected. Thus, the architecture of the embodiment provides the capability to maintain image quality while noise on some pixels is properly eliminated.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A noise reduction system, processing an input image to generate an output image, comprising:
a temporal module, comprising:
a temporal characteristic detector, detecting a temporal characteristic of the input image based on the input image and a reference image to generate a first selection signal;
a temporal filter, performing temporal noise reduction on the input image based on the reference image and the temporal characteristic to generate a temporal filtered image;
a temporal selector, selecting one of the temporal filtered image and the input image as a preliminary output based on the first selection signal;
a spatial module, coupled to the temporal selector, comprising:
a spatial characteristic detector, detecting a spatial characteristic of the input image based on the preliminary output to generate a second selection signal;
a spatial filter, performing spatial noise reduction on the input image based on the preliminary output and the temporal characteristic to generate a spatial filtered image;
a spatial selector, selecting one of the spatial filtered image and the preliminary output as the output image based on at least one of the first selection signal and second selection signal.

2. The noise reduction system as claimed in claim 1, wherein the output image is fed back to the temporal module to be the reference image.

3. The noise reduction system as claimed in claim 1, further comprising a frame buffer, buffering the input image and outputting a previous input image to be the reference image.

4. The noise reduction system as claimed in claim 1, wherein:
the temporal characteristic comprises a motion characteristic of the input image; and
the temporal characteristic detector compares the input image and the reference image to determine the motion characteristic, wherein:
if the input image is motionless, the temporal characteristic detector sends the first selection signal to direct the temporal selector to select the temporal filtered image as the preliminary output; and
if the input image is moving, the temporal characteristic detector sends the first selection signal to direct the temporal selector to select the input image as the preliminary output.

5. The noise reduction system as claimed in claim 1, wherein:
the spatial characteristic comprises an edge characteristic of a pixel in the preliminary output, wherein:
if the pixel is identified as an edge, the spatial characteristic detector sends the second selection signal to direct the spatial selector to select the pixel from the preliminary output to organize the output image; and
if the pixel is not an edge, the spatial characteristic detector sends the second selection signal to direct the spatial selector to select a corresponding pixel from the spatial filtered image to organize the output image.

6. The noise reduction system as claimed in claim 1, wherein:
the spatial characteristic further comprises a luminance characteristic of a pixel in the preliminary output, wherein:
if luminance of the pixel exceeds a luminance threshold, the spatial characteristic detector sends the second selection signal to direct the spatial selector to select the pixel from the preliminary output to organize the output image; and
if the luminance of the pixel does not exceed the luminance threshold, the spatial characteristic detector sends the second selection signal to direct the spatial selector to select a corresponding pixel from the spatial filtered image to organize the output image.

7. The noise reduction system as claimed in claim 1, wherein:
the spatial characteristic further comprises a chrominance characteristic of a pixel in the preliminary output, wherein:
if chrominance of the pixel exceeds a chrominance threshold, the spatial characteristic detector sends the second selection signal to direct the spatial selector to select the pixel from the preliminary output to organize the output image; and
if the chrominance of the pixel does not exceed the chrominance threshold, the spatial characteristic detector sends the second selection signal to direct the spatial selector to select a corresponding pixel from the spatial filtered image to organize the output image.

8. The noise reduction system as claimed in claim 1, wherein:
the spatial module further comprises a decision unit coupled to the temporal characteristic detector and the spatial characteristic detector, performing a logic decision based on the first selection signal and second selection signal to generate a third selection signal; and
the spatial selector selects one of the spatial filtered image and the preliminary output to be the output image based on the third selection signal.

9. A noise reduction system, processing an input image to generate an output image, comprising:
a spatial module, comprising:
a spatial characteristic detector, detecting a spatial characteristic of the input image to generate a first selection signal;
a spatial filter, performing spatial noise reduction on the input image based on the input image and the spatial characteristic to generate a spatial filtered image; and
a spatial selector, selecting one of the spatial filtered image and the input image as a preliminary output based on the first selection signal; and
a temporal module, coupled to the spatial selector, comprising:
a temporal characteristic detector, detecting a temporal characteristic of the input image based on the preliminary output and a reference image to generate a second selection signal;
a temporal filter, performing temporal noise reduction on the preliminary output based on the reference image and the temporal characteristic to generate a temporal filtered image; and
a temporal selector, selecting one of the temporal filtered image and the preliminary output as the output image based on the second selection signal.

10. The noise reduction system as claimed in claim 9, wherein the output image is fed back to the temporal module to be the reference image.

11. The noise reduction system as claimed in claim 9, wherein:
the spatial characteristic comprises an edge characteristic of a pixel in the input image, wherein:
if the pixel is identified as an edge, the spatial characteristic detector sends the first selection signal to direct the spatial selector to select the pixel from the input image to organize the preliminary output; and
if the pixel is not an edge, the spatial characteristic detector sends the first selection signal to direct the spatial selector to select a corresponding pixel from the spatial filtered image to organize the preliminary output.

12. The noise reduction system as claimed in claim 9, wherein:
the spatial characteristic comprises luminance characteristic of a pixel in the input image, wherein:
if luminance of the pixel in the input image exceeds a luminance threshold, the spatial characteristic detector sends the first selection signal to direct the spatial selector to select the pixel to organize the preliminary output; and
if the luminance of the pixel does not exceed the luminance threshold, the spatial characteristic detector sends the first selection signal to direct the spatial selector to select a corresponding pixel from the spatial filtered image to organize the preliminary output.

13. The noise reduction system as claimed in claim 9, wherein:
the temporal characteristic comprises a motion characteristic of the preliminary output; and
the temporal characteristic detector compares the preliminary output and the reference image to determine the motion characteristic, wherein:
if the preliminary output is motionless, the temporal characteristic detector sends the second selection signal to direct the temporal selector to select the temporal filtered image as the output image; and
if the preliminary output is moving, the temporal characteristic detector sends the second selection signal to direct the temporal selector to select the preliminary output as the output image.

14. A noise reduction system, processing an input image to generate an output image, comprising:
a temporal module, comprising:
a temporal characteristic detector, detecting a temporal characteristic of the input image based on the input image and a reference image to generate a first selection signal; and
a first temporal filter, performing temporal noise reduction on the input image based on the reference image and the temporal characteristic to generate a first temporal filtered image;
a spatial module, comprising:
a spatial characteristic detector, detecting a spatial characteristic of the input image based on the input image to generate a second selection signal; and
a first spatial filter, performing spatial noise reduction on the input image based on the input image and the spatial characteristic to generate a first spatial filtered image; and
a decision unit, coupled to the temporal module and spatial module, performing an organization process to render the output image from pixels of the first temporal filtered image, first spatial filtered image and the input image based on the first selection signal and the second selection signal.

15. The noise reduction system as claimed in claim 14, wherein:
the temporal characteristic comprises a motion characteristic of the input image; and
the temporal characteristic detector compares the input image and the reference image to determine the motion characteristic, wherein:
if the input image is motionless, the temporal characteristic detector sends the first selection signal to direct the decision unit to select the first temporal filtered image as the output image; and
if the input image is moving, the temporal characteristic detector sends the first selection signal to direct the decision unit to select the input image as the output image.

16. The noise reduction system as claimed in claim 14, wherein:
the spatial characteristic comprises an edge characteristic of a pixel in the input image, wherein:
if a pixel in the input image is identified as an edge, the spatial characteristic detector sends the second selection signal to direct the decision unit to select the pixel to organize the output image; and
if the pixel in the input image is not an edge, the spatial characteristic detector sends the second selection signal to direct the decision unit to select a corresponding pixel from the first spatial filtered image to organize the output image.

17. The noise reduction system as claimed in claim 14, wherein:
the spatial characteristic comprises a luminance characteristic of a pixel in the input image, wherein:
if luminance of the pixel exceeds a luminance threshold, the spatial characteristic detector sends the second selection signal to direct the decision unit to select the pixel to organize the output image; and
if the luminance does not exceed the luminance threshold, the spatial characteristic detector sends the second selection signal to direct the decision unit to select a corresponding pixel from the first spatial filtered image to organize the output image.

18. The noise reduction system as claimed in claim 14, further comprising a second temporal filter, coupled to the first spatial filter and the temporal characteristic detector, performing temporal noise reduction on the first spatial filtered image based on the reference image and the temporal characteristic from the temporal characteristic detector to generate a second temporal filtered image to the decision unit, wherein the decision unit performs the organization process to render the output image from pixels of the first temporal filtered image, the second temporal filtered image, the first spatial filtered image and the input image based on the first selection signal and the second selection signal.

19. The noise reduction system as claimed in claim 14, further comprising a second spatial filter, coupled to the first temporal filter and the spatial characteristic detector, performing spatial noise reduction on the first temporal filtered image based on the spatial characteristic from the spatial characteristic detector to generate a second spatial filtered image to the decision unit, wherein the decision unit performs the organization process to render the output image from pixels of the first temporal filtered image, the first spatial filtered image, the second spatial filtered image and the input image based on the first selection signal and the second selection signal.

20. The noise reduction system as claimed in claim 14, further comprising:
a second temporal filter, coupled to the first spatial filter and the temporal characteristic detector, performing temporal noise reduction on the first spatial filtered image based on the temporal characteristic and the reference image to generate a second temporal filtered image; and
a second spatial filter, coupled to the first temporal filter and the spatial characteristic detector, performing spatial noise reduction on the first temporal filtered image based on the temporal characteristic to generate a second spatial filtered image,
wherein the decision unit performs the organization process to render the output image from pixels of the first temporal filtered image, the second temporal filtered image, the first spatial filtered image, the second spatial filtered image and the input image based on the first selection signal and the second selection signal.

21. The noise reduction system as claimed in claim 14, wherein the output image is fed back to be the reference image.
